(19) United States
(12) Patent Application Publication
(10) Pub. No.: US 2004/0123815 A1
(43) Pub. Date: Jul. 1, 2004

(54) Vaporizer for supplying moistened air to an internal combustion engine

(76) Inventor: Elmo M. Peterson, Guymon, OK (US)

Correspondence Address: Norman B. Rainer, 2008 Fondulac Road, Richmond, VA, 23229, US

(21) Appl. No.: 10/330,658

(22) Filed: Dec. 30, 2002

(51) Int. Cl. F02B 47/00

(52) U.S. Cl. 123/25 R

(57) ABSTRACT

A vaporizer apparatus for creating a heated moisturized air stream that is fed to the carburetor of an internal combustion engine includes a vertically oriented elongated water holding vessel that contains coils for transferring heat

from the engine's coolant system to the water in the vessel. A flow of air is bubbled through the water to produce high turbulence and a moisturized air stream that exits the top of the vessel. The water level in the vessel is maintained constant by a water feed line controlled by a float device enclosed within a foraminous shroud that produces a calm water surface upon which the float device rests.

### BACKGROUND OF THE INVENTION

1. Field of the Invention

This invention relates to internal combustion engines, and more particularly concerns apparatus which utilizes combustion-generated heat to improve fuel efficiency and secure additional advantages.

2. Description of the Prior Art

Numerous engine economizer systems have been disclosed in the prior art. Various methods have been employed in attempts to increase fuel economy, promote more efficient combustion, and utilize the heat generated as a by-product of combustion. Eriksen U.S. Pat. No. 2,746,440 discloses a carburetion apparatus adapted to exchange heat from engine exhaust gases with the liquid gasoline. The gasoline is heated to vaporize a gaseous fuel supply which is substituted for the normal atomized fuel/air mixture. Similarly, Dwyre U.S. Pat. No. 3,713,429 discloses a system whereby gasoline is heated by either exhaust gasses or coolant fluid from the engine. Simultaneously, air is injected into the heated fuel to initiate the atomization prior to the fuel reaching the carburetor.

Fuel additives have been disclosed for improving engine efficiency. For example, in U.S. Pat. No. 4,068,639 to Cook discloses the blending of liquid propane with gasoline air in the carburetor, and utilizes exhaust back pressure to control the fuel mixture and flow.

Many systems have been disclosed which recirculate exhaust gases in a fuel/air mixture which is returned to the intake manifold of an engine, thereby heating the mixture to enhance combustion and reduce hydrocarbon emissions. The valve disclosed in U.S. Pat. No. 3,990,418 to Nohira and Tanaka is utilized in a system of this nature in order to prevent carburetor icing, a common occurrence due to the rapid cooling of water vapor contained in the exhaust gases.

Another method of providing greater engine economy has been the introduction of water vapor into the fuel/air mixture. Loby U.S. Pat. No. 3,908,613 utilizes special water mist injection nozzles to add a precisely metered mist of water vapor into each cylinder. The water vapor has several beneficial effects. It inhibits detonation, whereby a greater compression of fuel/air/water mixture may be achieved. The harmful mechanical degradation created by detonation within the cylinders under compression depletes power and reduces engine life. The water vapor also improves the electrical conductivity of the fuel/air mixture, thereby enhancing complete ignition of the mixture. The added water vapor further serves to accelerate expansion of gases in the cylinder during the power stroke, and reduces the operating temperature of the cylinder head. A leaner mixture of fuel may be used because the fuel mixture is often maintained richer than optimum for combustion purposes in order to prevent undesirable temperature rises in the cylinder heads. The Loby patent however, discloses a radically improved engine design which precludes the use of such water vapor induction in standard internal combustion engines.

The prior art discloses means for utilizing both exhaust gases and radiator coolant fluid as means for heating fuel. Although the engine heat is being utilized, the engine oil is still circulating in the engine at elevated temperatures. At higher temperature, motor oil is susceptible to breakdown in viscosity, and thereby has diminished friction-reducing capability. The higher temperatures also promote rapid degradation of the oil, thereby reducing its useful life.

U.S. Pat. No. 5,121,713 to Peterson discloses a water reservoir tank that derives heat from the vehicle's coolant and lubricating fluids to produce a moisture-laden heated air stream that is routed to the engine's carburetor. The water level in the tank is controlled by a vertically moveable float valve. Although the Peterson apparatus performs successfully, the float valve mechanism lacks reliability and does not permit servicing for maintenance purposes.

It is therefore an object of the present invention to provide an engine economizer system which will reduce the fuel consumption of an internal combustion engine per unit of work achieved.

It is another object of the present invention to provide a system of the aforesaid nature which will significantly reduce the level of hydrocarbon and carbon monoxide emissions from an internal combustion engine.

It is a further object of this invention to provide a system of the aforesaid nature which will increase the useful life of an internal combustion engine, its spark plugs, valves, motor oil, and exhaust system.

It is yet another object of the present invention to provide a system of the aforesaid nature which is easy to install and maintain, has a minimal number of moving parts, is durable, and amenable to low cost manufacture.

### SUMMARY OF THE INVENTION

The above and other beneficial objects and advantages are accomplished in accordance with the present invention by an improved vaporizer apparatus for supplying an internal combustion engine with a heated moistened air stream, said engine having a carburetor, intake manifold, lubricating system adapted to circulate a fluid lubricant throughout said engine, and cooling system adapted to circulate coolant fluid throughout said engine. Said vaporizer apparatus is comprised of a containment vessel having an interior region adapted to contain water and bounded by a cylindrical sidewall and top and bottom panels, said vessel having:

1) water level control means having water level detection means and water inlet valve, said control means adapted to maintain a constant amount of water within said containment vessel, as defined by the upper surface of said water,

2) an engine coolant fluid circuit comprised of rigid tubing having coils disposed beneath said water surface and having inlet and outlet extremities emergent from said containment vessel, said inlet extremity adapted to receive heated engine coolant fluid from said engine cooling system, said outlet extremity adapted to return said coolant fluid to said cooling system,

3) an engine lubricant circuit comprised of rigid tubing having coils disposed beneath said water surface, and having inlet and outlet extremities emergent from said containment vessel, said inlet extremity adapted to receive lubricant from said engine lubricating system, said outlet extremity adapted to return said lubricant to said lubricating system,

4) an elongated air passage having an upper extremity emergent from said top panel and a lower extremity disposed beneath said water surface, and

5) air disbursement means horizontally disposed beneath said water surface and having a proximal extremity communicating with said lower extremity, said disbursement means having a plurality of air escape orifices.

The following features are interactive with said vaporizer apparatus to achieve the overall sought effect:

a) a water reservoir adapted to supply water to said vessel by way of said water level control means, thereby maintaining a constant level of water within said vessel,

b) air filter means associated with the upper extremity of said air passage and adapted to filter air drawn into said containment vessel,

c) a vacuum aspiration port penetrating said top panel and a adapted to permit emergence of a heated and moistened air stream from said vessel, and

d) engine induction means associated with said carburetor or intake manifold and adapted to draw in said moistened air stream by means of a hose connection to said aspiration port.

The present invention provides an improvement in the water level control means of the aforesaid vaporizer apparatus. In particular, a water level control mechanism is provided which is comprised of a float device having an attached elongated lever arm extending to a pivotably secured distal extremity interactive with a water inlet valve, and disposing said float device upon the surface of the water in said vessel such that varied elevations of said surface produce movement of said float device in a circular arc path in a vertical plane and centered upon said distal extremity. Said distal extremity and valve are located in a housing that extends horizontally outward from said sidewall to an outermost extremity. Said housing is in water-tight communication with said vessel, and has a servicing port disposed at said outermost extremity.

In order to enable the float device to function properly in spite of the very high turbulence existing within the containment vessel, it has been found necessary to enclose said float device within foraminous shroud means that creates a reasonably calm and accurately defined water surface upon which said float device can rest.

In preferred embodiments, the containment vessel may be equipped with stabilizing feet, a drain plug, and a lifting ring. The vessel may also have a sight glass penetrating the sidewall in order to monitor the water level within, and insulating material covering all outer surfaces.

### BRIEF DESCRIPTION OF THE DRAWING

For a fuller understanding of the nature and objects of the invention, reference should be had to the following detailed description taken in connection with the accompanying drawing forming a part of this specification and in which similar numerals of reference indicate corresponding parts in all the figures of the drawing:

FIG. 1 is a schematic view of an embodiment of the engine economizer system of the present invention.

FIG. 2 is a vertical sectional view of a containment vessel useful in the embodiment of FIG. 1.

FIG. 3 is a horizontal section view taken in the direction of the arrows upon the line 3-3 of FIG. 2.

FIG. 4 is a sectional view taken in the direction of the arrows upon the line 4-4 of FIG. 2.

### DESCRIPTION OF THE PREFERRED EMBODIMENT

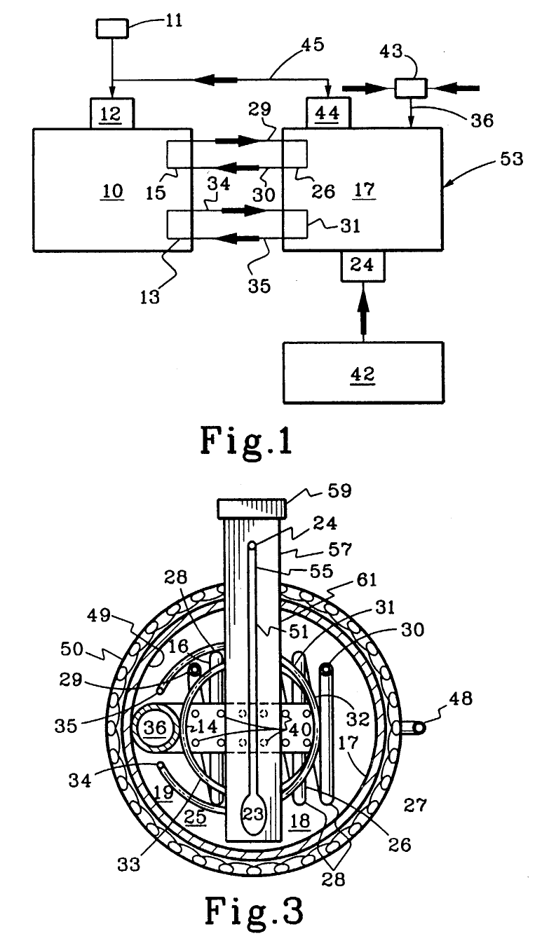

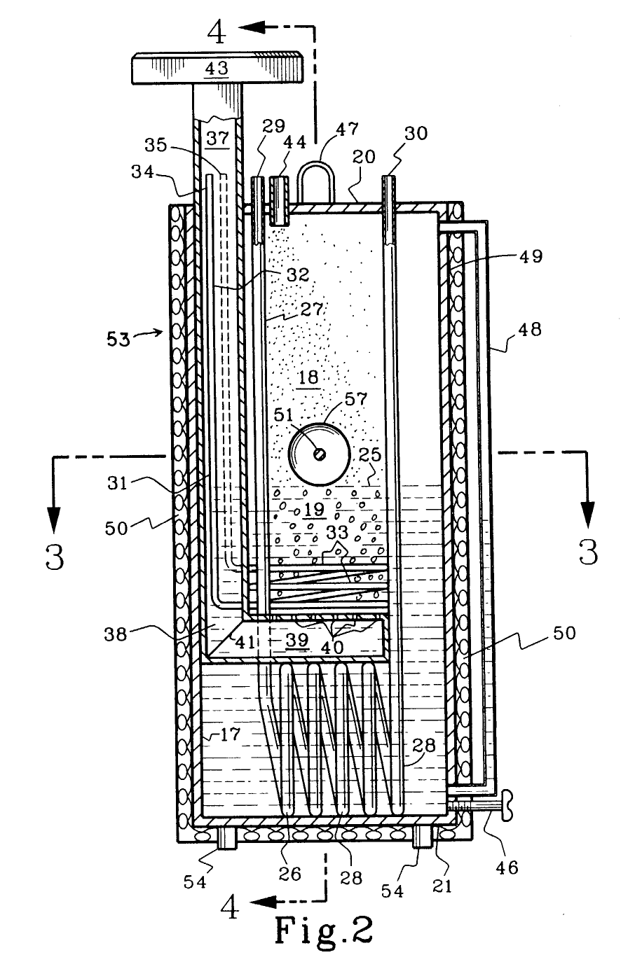

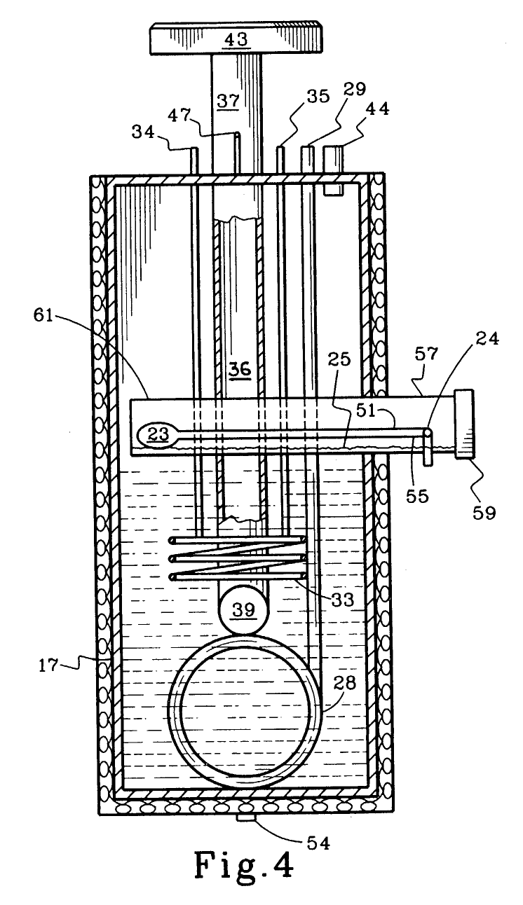

Referring now to FIGS. 1-4, an embodiment 53 of the engine economizer system of the present invention is shown in operative association with an engine 10 having a carburetor 11, intake manifold 12, lubricating system 13 adapted to circulate lubricant throughout engine 10, and cooling system 15 adapted to circulate coolant fluid throughout engine 10.

The economizer system is comprised of a containment vessel in the form of steel tank 17 having interior region 18 adapted to contain water 19 and bounded by top and bottom panels 20 and 21, respectively, and cylindrical sidewall 49. Engine coolant fluid circuit 26 is comprised of rigid tubing 27 having coils 28 disposed beneath water surface 25. Inlet and outlet extremities 29 and 30, respectively, emerge from top panel 20. Inlet extremity 29 is adapted to receive heated engine coolant fluid via a conventional hose from engine cooling system 15. Outlet extremity 30 is adapted to return coolant fluid via a conventional hose to said cooling system.

Engine lubricant circuit 31 is comprised of rigid tubing 32 having coils 33 disposed beneath water surface 25. Inlet and outlet extremities 34 and 35, respectively, emerge from top panel 20. Inlet extremity 34 is adapted to receive lubricating oil via a conventional hose from engine lubricating system 13. Outlet extremity 35 is adapted to return lubricating oil via a conventional hose to said lubricating system.

Elongated tubular air passage 36 is vertically disposed within tank 17 and has upper extremity 37 emergent from top panel 20 and lower extremity 38 disposed beneath water surface 25. Air disbursement or sparger means 39, having air escape orifices 40, is horizontally disposed beneath water surface 25 and has a proximal extremity 41 communicating with lower extremity 38. Air which emerges from said orifices creates extremely turbulent conditions within the tank.

Air filter means 43 is associated with upper extremity 37 of said air passage and is adapted to filter air drawn into said containment tank. Vacuum aspiration port 44 penetrates top panel 20 and is adapted to permit emergence of the heated air and water vapor mixture produced in said tank. Hose 45 conveys the heated air and water vapor mixture from aspiration port 44 to intake manifold 12.

A water level control mechanism is provided which is comprised of water level detection means in the form of float device 23 having an attached elongated lever arm 51 extending to a pivotably secured distal extremity 55 interactive with water inlet valve 24. Said float device is disposed within foraminous shroud means exemplified in the form of horizontally oriented porous tube 61 positioned such that the desired water level will reside within said tube. The purpose of said shroud means is to create a calm water surface upon which float device 23 can rest. In the absence of said shroud means, the turbulence within the tank would not permit said float device to operate effectively. The shroud means may be a perforated pipe, a cylindrical screen or equivalent water-permeable enclosure having pores of adequate size to permit passage of water while preventing passage of large sized bubbles of air.

Flat device 23 is adapted to rest upon the calmed surface of water in the shroud means in a manner such that varied elevations of said surface produce movement of the float device in a circular arc path in a vertical plane and centered upon distal extremity 55. Said distal extremity and valve are located in a housing 57 that extends horizontally outward from said sidewall to an outermost extremity 58. Said housing, which may be a non-permeable extension of tube 61, is in water-tight communication with said vessel, and has a screw-cap servicing port 59 disposed at said outermost extremity. A water inlet port 60 is associated with housing 57. Water reservoir 42 is adapted to supply water to port 60 as dictated by the action of valve 24, thereby maintaining a constant level of water 19 within said tank, said level defined by water surface 25.

Containment tank 17 is further equipped with stabilizing feet 54, drain plug 46 which penetrates sidewall 49, and lifting ring 47 attached to top panel 20. A sight glass 48 penetrates the sidewall 49 in order to permit visual monitoring of the height of the water surface 25. Insulating material 50 is associated with all outer surfaces of said tank.

As air is drawn into intake manifold 12 from aspiration port 44, a vacuum is created above water level 25, causing fresh air to be drawn through air passage 36 and filter 43. The air enters disbursement means 39 through proximal extremity 41 and bubbles upward from orifices 40. Water 19 contained in tank 17 is heated by passage of hot coolant fluid and lubricant fluid through circuits 31 and 26, respectively. Air bubbling through the heated water 19 generates an air-water vapor mixture which is aspirated through port 44 and drawn into engine 10 through induction hose 45.

Because of the considerable leverage applied by arm 51 to valve 24, the level of water in the tank is accurately controlled. By virtue of servicing port 59, the interior of the tank is readily accessible for cleaning and maintenance purposes.

While particular examples of the present invention have been shown and described, it is apparent that changes and modifications may be made therein without departing from the invention in its broadest aspects. The aim of the appended claims, therefore, is to cover all such changes and modifications as fall within the true spirit and scope of the invention.

Having thus described my invention, what is claimed is:

1.) In a vaporizer apparatus for delivering a moistened air stream to a fluid-cooled internal combustion engine and comprised of a vertically elongated water holding vessel having coils that convey heat from said cooling fluid to said water, air intake means that generate a turbulent state within said vessel, and control means for maintaining a constant surface level of water within said vessel, the improvement in said control means comprising a float device having an attached elongated lever arm extending substantially horizontally to a pivotably secured extremity interactive with a water intake valve, and foraminous shroud means that enclose said float device to creat a calm and accurately defined water surface upon which said float device rests.

2.) The apparatus of claim 1 wherein said engine is further equipped with a circulating lubricating fluid system, and said vessel additionally contains coils that convey heat from said lubricating system to said water.

3.) The apparatus of claim 2 wherein said water vessel is bounded by a cylindrical sidewall and top and bottom panels.

4.) The apparatus of claim 3 wherein said intake valve is located in a housing extending laterally away from said sidewall.

5.) The apparatus of claim 4 wherein said air intake means enters said vessel through said top panel.

6.) The apparatus of claim 5 wherein said turbulent state is produced by the release of air from said air intake means in bubbled form at a site below said water surface.

7.) The apparatus of claim 6 wherein said top panel is provided with an aspiration port that permits emergence of said moisturized air stream from said vessel.

8.) The apparatus of claim 7 wherein said housing is coextensive with said shroud means.
